(19) United States
(12) Patent Application Publication
(10) Pub. No.: US 2015/0142636 A1
(43) Pub. Date: May 21, 2015

(54) RISK MITIGATION TOOL FOR MONITORING TRADING LIMITS

(71) Applicant: The Depository Trust & Clearing Corporation, New York, NY (US)

(72) Inventor: William J. Kapogiannis, Poughkeepsie, NY (US)

(21) Appl. No.: 14/540,433

(22) Filed: Nov. 13, 2014

Related U.S. Application Data
(60) Provisional application No. 61/904,785, filed on Nov. 15, 2013.

(51) Int. Cl. G06Q 40/04

(52) U.S. Cl. CPC G06Q 40/04
USPC 705/37

(57) ABSTRACT

In various embodiments, methods, systems, and computer program products may be provided for monitoring a risk entity's trading activity and/or risk exposure and providing one or more alerts and/or reports regarding the same. In one embodiment, a system is provided comprising at least one memory for storing one or more limits, each limit associated with a risk entity. The system may further comprise at least one processor that may be configured to receive trading activity data associated with the risk entity from a plurality of sources; consolidate the received trading activity data; execute a predetermined algorithm to calculate at least one risk exposure metric based at least in part on the consolidated trading activity data; determine, based at least in part on the calculated risk exposure metric, whether at least one of the limits has been triggered; and generate an alert indicative of the triggering.

### CROSS-REFERENCE TO RELATED APPLICATIONS

This application claims priority to U.S. Application No. 61/904,785, filed Nov. 15, 2013, which is incorporated in its entirety by reference herein.

### BACKGROUND

The present invention is generally related to monitoring trading activity and/or risk exposure of an entity participating in an equity marketplace.

A clearing firm may manage transactions for a large number of risk entities participating in the equity marketplace, making it difficult to monitor the trading activity and/or risk exposure of each individual risk entity. Additionally, a risk entity may participate in transactions in a number of different exchanges and off-exchange markets, increasing the difficulty of monitoring an individual risk entity's trading activity and/or risk exposure across all such exchanges or otherwise. For example, a risk entity may have position in equity, corporate and municipal bonds as well as unit investment trusts (UIT).

Thus, a need exists for improved methods, systems, and tools for monitoring the trading activity and managing the risk exposure of risk entities participating across one or more markets.

### BRIEF SUMMARY

The present invention generally provides a risk mitigation tool for monitoring trading activity and managing the risk exposure of a risk entity. Particularly, a risk mitigation tool for monitoring the risk entity's risk exposure across various equity marketplaces is provided. A user of the risk mitigation tool may set a breach limit for a risk entity associated with the user. In various embodiments, the user may be alerted if the risk entity's trading activity and/or risk exposure has reached or surpassed a pre-established breach limit of trading activity and/or risk exposure. In various embodiments, the user may be alerted if the risk entity's trading activity and/or risk exposure has reached or surpassed one or more pre-established early-warning limits some degree below the breach limit of trading activity and/or risk exposure. In various embodiments, the risk mitigation tool may be configured to provide alerts in real-time or near real-time. In some embodiments, the user may also be able to review information related to the risk entity's trading activity and/or risk exposure on a real-time, near real-time, intra-day, end-of-day, monthly, quarterly, and/or yearly basis. In these and other embodiments, users may be prompted to perform further mitigating activities in response to or as a portion of receiving the alert from the risk mitigation tool. In these and other embodiments, the alert may be embodied in any of a variety of communication mediums, including the non-limiting examples of e-mails, texts, and the like.

In one aspect of the present invention, a system is provided. In various embodiments, the system may comprise at least one memory for storing one or more limits, each limit associated with a risk entity. The system may further comprise at least one processor. The at least one processor may be configured to receive trading activity data associated with the risk entity from a plurality of sources; consolidate the received trading activity data; and execute a predetermined algorithm to calculate at least one risk exposure metric based at least in part on the trading activity. The at least one processor may be further configured to determine, based at least in part on the calculated risk exposure metric, whether at least one of the one or more limits associated with the risk entity has been triggered; and generate an alert indicative of the triggering of the at least one of the one or more limits.

In another aspect of the present invention, a computer-implemented method is provided. In various embodiments, the method may comprise receiving and storing within one or more memory storage areas trading activity data associated with the risk entity from a plurality of sources; consolidating, via at least one processor, the received trading activity data; executing, via the at least one processor, a predetermined algorithm to calculate at least one risk exposure metric, said calculation of said at least one risk exposure metric being based at least in part on the consolidated trading activity data; determining, based at least in part on the calculated risk exposure metric, whether at least one of one or more limits associated with the risk entity has been triggered; and generating an alert indicative of said triggering of said at least one of the one or more limits.

In yet another aspect of the present invention, a computer program product is provided. In various embodiments, the computer program product may comprise at least one non-transitory computer-readable storage medium having computer-readable program code portions stored therein. The computer-readable program code portions may comprise an executable portion configured to store one or more limits, each limit associated with a risk entity; an executable portion configured to receive trading activity data associated with the risk entity from a plurality of sources; an executable portion configured to consolidate the received trading activity data; an executable portion configured to execute a predetermined algorithm to calculate at least one risk exposure metric based at least in part on the consolidated trading activity data; an executable portion configured to determine, based at least in part on the calculated risk exposure metric, whether at least one of the one or more limits associated with the risk entity has been triggered; and an executable portion configured to generate an alert indicative of said triggering of said at least one of the one or more limits.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates one embodiment of a system for use in a Risk Mitigation Tool, in accordance with the present invention;

FIG. 2 is a schematic diagram of an monitoring server, in accordance with various embodiments of the present invention;

FIG. 3 is a flowchart illustrating an example process of establishing breach limits for a risk entity, in accordance with various embodiments of the present invention; and

FIGS. 4A, 4B, and 4C are flowcharts illustrating some example processes of monitoring the trading activity and/or risk exposure of a risk entity, in accordance with various embodiments of the present invention.

### DETAILED DESCRIPTION OF VARIOUS EMBODIMENTS

The present invention now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

### Methods, Apparatus, Systems, and Computer Program Products

As should be appreciated, the embodiments may be implemented as methods, apparatus, systems, or computer program products. Accordingly, the embodiments may take the form of an entirely hardware embodiment, an entirely software embodiment, or an embodiment combining software and hardware aspects. Furthermore, the various implementations may take the form of a computer program product on a computer-readable storage medium having computer-readable program instructions (e.g., computer software) embodied in the storage medium. More particularly, implementations of the embodiments may take the form of web-implemented computer software. Any suitable computer-readable storage medium may be utilized including hard disks, CD-ROMs, optical storage devices, or magnetic storage devices.

The embodiments are described below with reference to block diagrams and flowchart illustrations of methods, apparatus, systems, and computer program products. It should be understood that each block of the block diagrams and flowchart illustrations, respectively, can be implemented by computer program instructions, e.g., as logical steps or operations. These computer program instructions may be loaded onto a general purpose computer, special purpose computer, or other programmable data processing apparatus to produce a machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, can be implemented by special purpose hardware-based computer systems that perform the specified functions or operations, or combinations of special purpose hardware and computer instructions.

In general, the terms computing entity, entity, device, system, and/or similar words used herein interchangeably may refer to, for example, one or more computers, computing entities, computing devices, mobile phones, desktops, tablets, notebooks, laptops, distributed systems, servers, blades, gateways, switches, processing devices, processing entities, relays, routers, network access points, base stations, the like, and/or any combination of devices or entities adapted to perform the functions, operations, and/or processes described herein. Such functions, operations, and/or processes may include, for example, transmitting, receiving, operating on, processing, displaying, storing, determining, creating/generating, monitoring, evaluating, comparing, and/or similar terms used herein interchangeably. In one embodiment, these functions, operations, and/or processes can be performed on data, content, information, and/or similar terms used herein interchangeably.

### General Overview

In various embodiments, the present invention provides methods, systems, and computer program products for monitoring a risk entity's trading activity and/or risk exposure. A user (e.g., a clearing broker, clearing firm, and/or the like) may submit limit information associated with the risk entity (e.g., a client of the user and/or the user itself), such as a breach limit. One or more early-warning limits may be generated systemically (e.g., a certain percentage of the breach limit, and/or the like), through input from the users, or some combination thereof. In one embodiment, the user may also provide user alert preferences. The user may also provide input indicating a start-of-day position associated with a risk exposure entity. The start-of-day position and the subsequent trading activity data may then be consolidated for the purpose of position calculation. For example, the start-of-day position and/or consolidated trading activity data may be used to calculate one or more risk exposure metrics associated with the risk exposure of the risk entity. The one or more risk exposure metrics associated with the risk entity may be monitored to determine if the risk entity's trading activity has reached and/or surpassed the breach limit and/or an early-warning limit. If the risk entity's trading activity has reached or surpassed the breach limit and/or an early-warning limit, an alert may be provided to the user. In various embodiments, a web-accessible portal may be provided. In various embodiments, users may provide limit information, user alert preferences, view real-time or near real-time trading activity and/or risk exposure information for a risk entity, and/or the like via the portal. Various system architectures that may be used in accordance with the present invention will now be described herein.

### System Architecture

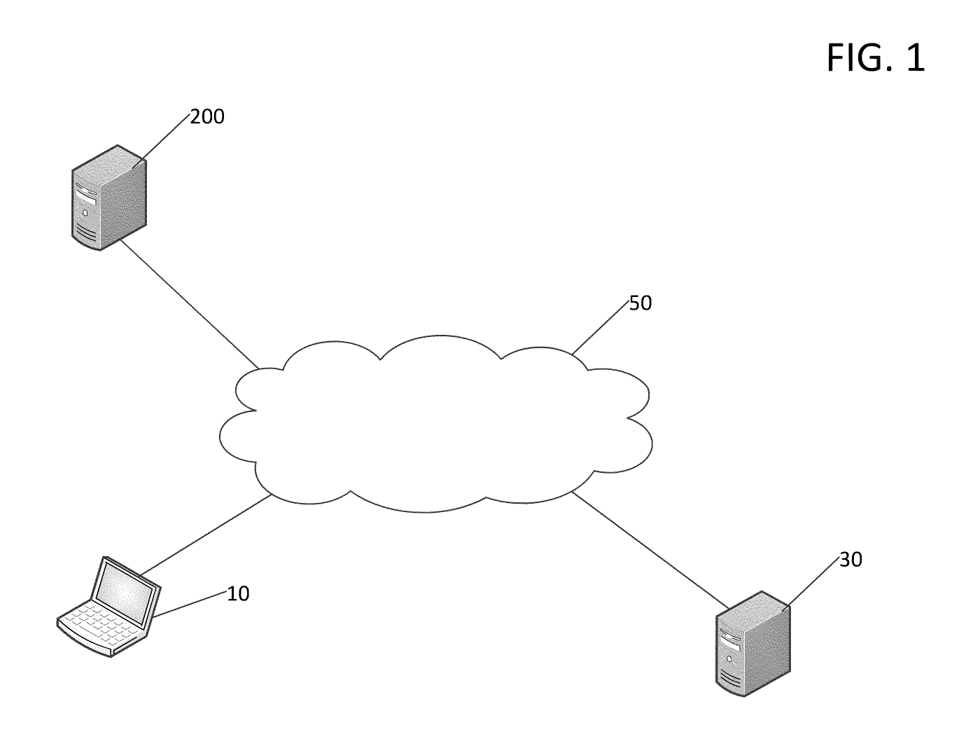

FIG. 1 illustrates one example embodiment of a system that may implement the present invention. The illustrated system includes one or more user computing devices 10, one or more monitoring servers 200, and one or more clearing systems 30. The one or more user computing devices 10, the one or more monitoring servers 200, and the one or more clearing systems 30 may communicate via one or more wired or wireless networks 50.

In various embodiments, a user computing device 10 may provide a monitoring server 200 with limit information and/or user alert preferences. One or more clearing systems 30 may provide the monitoring server 200 with trading activity data. The monitoring server 200 may be configured to receive the limit information and/or user alert preferences from the user computing device 10 and/or receive trading activity data from one or more clearing systems 30. The monitoring server 200 may be further configured to consolidate the trading activity data, calculate one or more risk exposure metrics associated with the risk entity, and/or determine if the risk entity has reached and/or surpassed the breach limit and/or an early-warning limit associated with the risk entity. Additionally, the monitoring server 200 may be configured to transmit one or more alerts to the user computing device 10.

As should be appreciated by one of skill in the art, a user may submit limit information and/or user alert preferences associated with one or more risk entities. Additionally multiple user's may submit limit information and/or user alert preferences associated with one or more risk entities. In some embodiments more than one user may submit limit information and/or user alert preferences associated with a risk entity (e.g., the risk entity may be client of Broker A in exchange A and a client of Broker B in exchange B, thus both Broker A and Broker B may submit limit information and/or user alert preferences associated with the risk entity). The monitoring server 200, user computing device 10, and the clearing system 30 will now each be discussed in detail below herein.

Monitoring Server 200

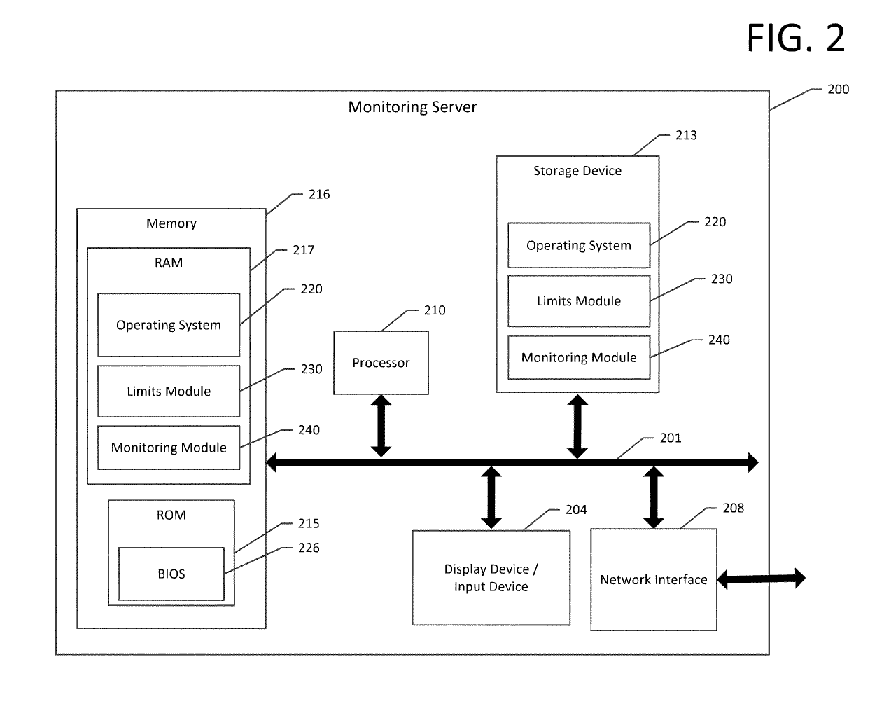

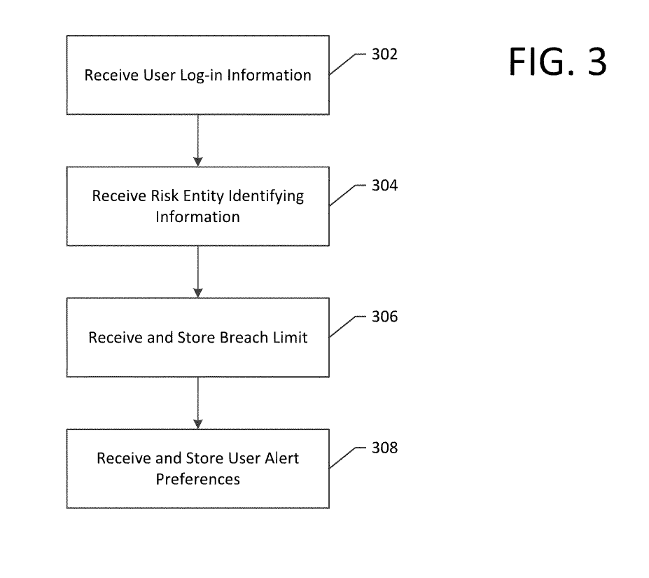

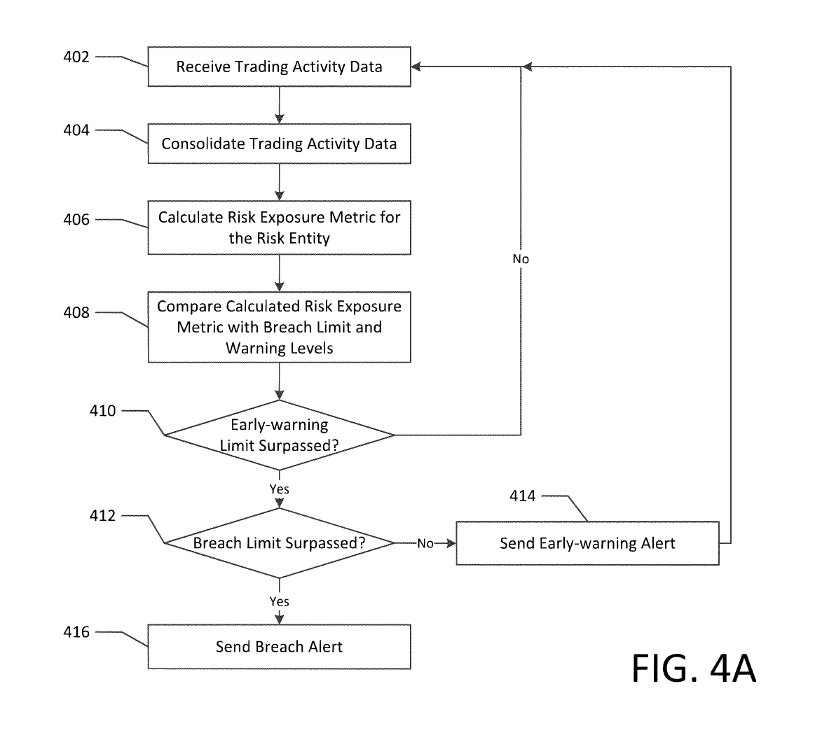

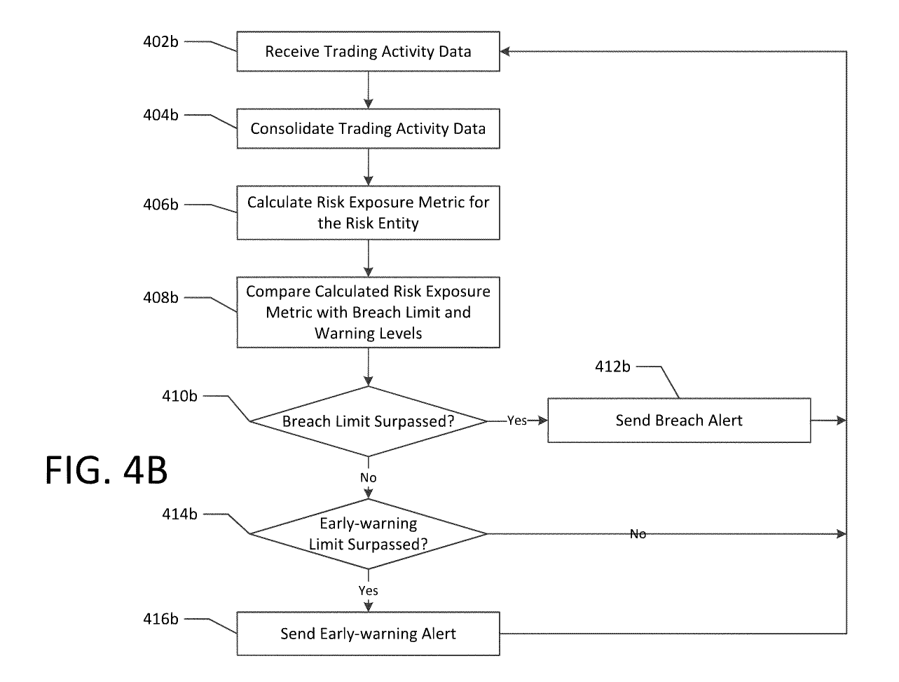

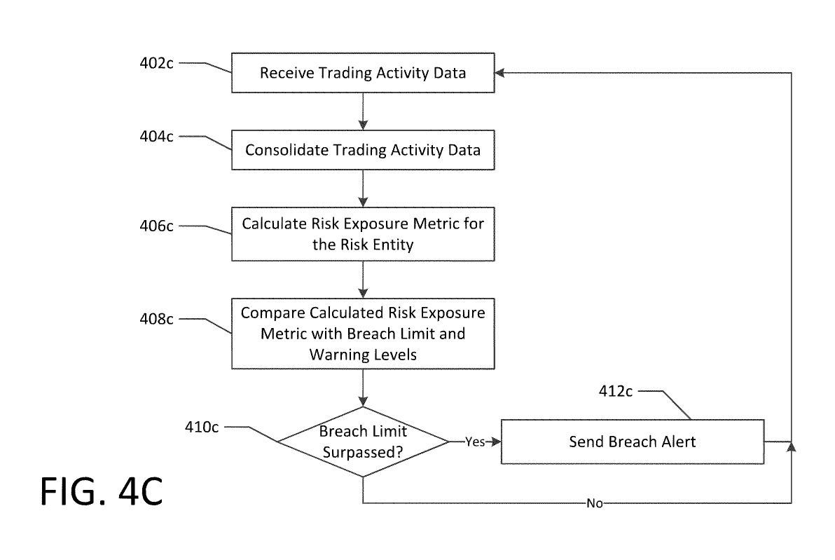

FIG. 2 provides a schematic diagram of an example monitoring server 200. The monitoring server 200 comprises a processor 210, such as one or more processing elements, which may include complex programmable logic devices (CPLDs), microprocessors, multi-core processors, co-processing entities, application-specific instruction-set processors (ASIPs), and/or controllers or other processing devices or circuitry. The term circuitry may refer to an entirely hardware embodiment or a combination of hardware and computer program products. Thus, the processor 210 may be embodied as integrated circuits, application specific integrated circuits (ASICs), field programmable gate arrays (FPGAs), programmable logic arrays (PLAs), hardware accelerators, other circuitry, and/or the like. As will therefore be understood, the processor 210 may be configured for a particular use or configured to execute instructions stored in volatile or non-volatile media or otherwise accessible to the processor 210. As such, whether configured by hardware or computer program products, or by a combination thereof, the processor 210 may be capable of performing steps or operations according to embodiments of the present invention, such as the embodiments illustrated in FIGS. 3 and 4, when configured accordingly. The processor 210 is used to execute software instructions for carrying out the defined steps of the method of the various embodiments of the present invention. The processor 210 communicates using a data bus 201 that is used to convey data and program instructions, typically, between the processor and memory 216.

The monitoring server 200 further includes memory 216, which may comprise non-volatile media (also referred to as non-volatile storage, memory, memory storage, memory circuitry and/or similar terms used herein interchangeably). In one embodiment, the non-volatile storage or memory may include one or more non-volatile storage or memory media as described above, such as hard disks, ROM, PROM, EPROM, EEPROM, flash memory, MMCs, SD memory cards, Memory Sticks, CBRAM, PRAM, FeRAM, RRAM, SONOS, racetrack memory, and/or the like. In various embodiments, memory 216 includes both read only memory (ROM) 215 and random access memory (RAM) 217. As will be recognized, the non-volatile storage or memory media may store databases, database instances, database management systems, data, applications, programs, program modules, scripts, source code, object code, byte code, compiled code, interpreted code, machine code, executable instructions, and/or the like. Such code may include the limits module 230 and/or the monitoring module 240. The term database, database instance, database management system, and/or similar terms used herein interchangeably may refer to a structured collection of records or data that is stored in a computer-readable storage medium, such as via a relational database, hierarchical database, and/or network database.

In at least one embodiment, the monitoring server 200 may further include or be in communication with volatile media (also referred to as volatile storage, memory, memory storage, memory circuitry and/or similar terms used herein interchangeably). In one embodiment, the volatile storage or memory may also include one or more volatile storage or memory media as described above, such as RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. As will be recognized, the volatile storage or memory media may be used to store at least portions of the databases, database instances, database management systems, data, applications, programs, program modules, scripts, source code, object code, byte code, compiled code, interpreted code, machine code, executable instructions, and/or the like being executed by, for example, the processor 210. Thus, the databases, database instances, database management systems, data, applications, programs, program modules, scripts, source code, object code, byte code, compiled code, interpreted code, machine code, executable instructions, and/or the like may be used to control certain aspects of the operation of the monitoring server 200 with the assistance of the processor 210 and operating system 220, such as the limits module 230, and/or the monitoring module 240.

In various embodiments, memory 216 can be considered primary memory such as RAM memory or other forms which retain the contents only during operation, or it may be a non-volatile memory, such as ROM, EPROM, EEPROM, FLASH, or other types of memory that retain the memory contents. In some embodiments, the disk storage may communicate with the processor 210 using an I/O bus instead of a dedicated bus 201. The memory 216 could also be secondary memory, such as disk storage, that stores a relatively large amount of data. The secondary memory may be a floppy disk, hard disk, compact disk, DVD, or any other type of mass storage type known to those skilled in the computer arts. The memory may also comprise any application program interface, system, libraries and any other data by the processor to carry out its functions. ROM 215 is used to store a basic input/output system 226 (BIOS), containing the basic routines that help to transfer information between components of the monitoring server 200, including the limits module 230, monitoring module 240, and/or the operating system 220.

In addition, the monitoring server 200 includes at least one storage device 213, such as a hard disk drive, a floppy disk drive, a CD-ROM drive, or optical disk drive, for storing information on various computer-readable media, such as a hard disk, a removable magnetic disk, or a CD-ROM disk. As will be appreciated by one of ordinary skill in the art, each of these storage devices 213 is connected to the system bus 201 by an appropriate interface. It is important to note that the computer-readable media described above could be replaced by any other type of computer-readable media known in the art. Such media include, for example, memory sticks (e.g., USB memories), magnetic cassettes, flash memory cards, digital video disks, and Bernoulli cartridges.

A number of program modules may be stored by the various storage devices and within RAM 217. Such program modules may include the operating system 220, the limits module 230, and/or the monitoring module 240. Those skilled in the art will appreciate that other modules may be present in RAM 217 to effectuate the various embodiments of the present invention. Furthermore, rather than program modules, the limits module 230, and/or the monitoring module 240 may comprise one or more stand-alone computers connectively coupled to the monitoring server 200.

Also located within the monitoring server 200 is a network interface 208, for interfacing and communicating with other elements of a computer network, such as by communicating data, content, information, and/or similar terms used herein interchangeably that can be transmitted, received, operated on, processed, displayed, stored, and/or the like. For instance, the monitoring server 200 may be in communication with one or more user computing devices 10 and/or one or more clearing systems 30. Such communication may be executed using a wired data transmission protocol, such as fiber distributed data interface (FDDI), digital subscriber line (DSL), Ethernet, asynchronous transfer mode (ATM), frame relay, data over cable service interface specification (DOCSIS), or any other wired transmission protocol. Similarly, the monitoring server 200 may be configured to communicate via wireless external communication networks using any of a variety of protocols, such as general packet radio service (GPRS), Universal Mobile Telecommunications System (UMTS), Code Division Multiple Access 2000 (CDMA2000), CDMA2000 1X (1xRTT), Wideband Code Division Multiple Access (WCDMA), Time Division-Synchronous Code Division Multiple Access (TD-SCDMA), Long Term Evolution (LTE), Evolved Universal Terrestrial Radio Access Network (E-UTRAN), Evolution-Data Optimized (EVDO), High Speed Packet Access (HSPA), High-Speed Downlink Packet Access (HSDPA), IEEE 802.11 (Wi-Fi), 802.16 (WiMAX), ultra wideband (UWB), infrared (IR) protocols, Bluetooth protocols, wireless universal serial bus (USB) protocols, and/or any other wireless protocol.

Various information is input by a user or service provider to the monitoring server 200 via the network interface 208 and/or input/output device 204. This input information may include information related to limit information, user alert preferences, trading activity data, or other information. This input information may vary, however, depending on the configuration and informational requirements of the monitoring server 200.

As mentioned above, the monitoring server 200 also includes an input/output device 204 for receiving and displaying data. The monitoring server 200 may include or be in communication with one or more input elements, such as a keyboard input, a mouse input, a touch screen/display input, audio input, pointing device input, joystick input, keypad input, and/or the like, as indicated by input/output device 204. The monitoring server 200 may also include or be in communication with one or more output elements, as indicated by input/output device 204, such as audio output, video output, screen/display output, motion output, movement output, and/or the like.

The monitoring server 200 is configured to monitor the trading activity of a risk entity and provide alerts to a user in accordance with user defined breach limits. In various embodiments, the monitoring server 200 may be configured to receive limit information and/or user alert preferences from a user computing device 10. In various embodiments, the monitoring server may be configured to receive trading activity data from one or more clearing systems 30. The monitoring server 200 may be further configured to consolidate the trading activity data, calculate one or more risk exposure metrics for the risk entity, transmit early-warning and/or breach alerts to the user computing device 10 in accordance with user defined early-warning and/or breach limits, user alert preferences, and/or the like. In various embodiments, the monitoring server 200 is further configured to provide a web-accessible portal configured to receive input including limit information and/or user alert preferences, possibly from a user computing device 10 and/or providing real-time or near real-time trading activity information for the risk entity. In various embodiments, the monitoring server 200 is configured to perform the processes and/or at least a portion of the processes illustrated in FIGS. 3 and 4.

Those skilled in the art will recognize that many other alternatives and architectures are possible and can be used to practice various embodiments of the invention. The embodiment illustrated in FIG. 2 can be modified in different ways or incorporated within a network and be within the scope of the invention. For example, one or more components of the monitoring server 200 may be located remotely from other monitoring server 200 components, such as in a distributed system. Furthermore, one or more of the components may be combined and additional components performing functions described herein may be included in the monitoring server 200. Thus, the monitoring server 200 can be adapted to accommodate a variety of needs and circumstances.

User Computing Device 10

In various embodiments, a user computing device 10 may be any computing device operated by or on behalf of a user of the Risk Management Tool. A user may be a clearing broker, clearing firm, and/or the like. In one embodiment, the user computing device 10 may include one or more components that are functionally similar to those of the monitoring server 200. For example, in one embodiment, the user computing device 10 may include one or more processing elements, one or more display device/input devices, volatile and non-volatile storage or memory, and/or one or more communications interfaces. The user computing device 10 may also comprise various other systems. In particular, the user computing device 10 may include components configured to submit limit information and/or user alert preferences to the monitoring server 200, receive alerts from the monitoring server 200, access the web-accessible portal, and/or the like. The user computing device 10 may be in communication with the monitoring server 200, and/or other computing devices.

Clearing System 30

A clearing system 30 may be any computing device configured to provide the monitoring server 200 with trading activity data. In various embodiments, the clearing system 30 may be operated by and/or associated with a clearing house, clearing firm, and/or the like. In one embodiment, the clearing system 30 may include one or more components that are functionally similar to those of the monitoring server 200. For example, in one embodiment, the clearing system 30 may include one or more processing elements, one or more display device/input devices, volatile and non-volatile storage or memory, and/or one or more communications interfaces. The clearing system 30 may also comprise various other systems. In particular, the clearing system 30 may include components configured to submit trading activity data to the monitoring server 200 and/or the like. The clearing system 30 may be in communication with the monitoring server 200, and/or other computing devices.

System Operation

As indicated above, various embodiments of the monitoring server 200 may operate various modules (e.g., modules 230, 240). In various embodiments, the limits module 230 is configured to receive input indicating limit information and/or user alert preferences, possibly via a user computing device 10, and/or the like. In various embodiments, the monitoring module 240 is configured to receive trading activity data from one or more clearing systems 30, calculate one or more risk exposure metrics for the risk entity, provide alerts to the user computing device 10, and/or the like. As should be appreciated, various embodiments may combine the functionality of the modules 230, 240 or may substitute one or more modules 230, 240 for other methods to incorporate the functionality described herein with respect to the modules 230, 240.

Limits Module 230

As noted above, the limits module 230 may be configured to receive input indicating limit information and/or user alert preferences from a user computing device 10. In various embodiments the limit information may comprise a breach limit, one or more early-warning limits, and/or the like. In various embodiments, the user alert preferences may comprise alert format preferences, an electronic address for alerts to be transmitted to, and/or the like. The function of the limits module 230 will now be described in more detail with respect to FIG. 3.

FIG. 3 is a flowchart showing the processes performed by the limits module 230 in one embodiment. At step 302, a user (e.g., operating a user computing device 10) provides input indicating log-in information to log-in to web-accessible portal, via the user computing device 10. If the user does not already have a user account for accessing the portal, the user may be directed to provide information necessary for establishing a user account. For example, the user (e.g., operating a user computing device 10) may be prompted to provide input indicating identifying information for the user (e.g., name, address, telephone number, email address, and/or the like), a user name, a password, and/or the like. Once the user is logged in to the web-accessible portal, the user may enter input indicating and/or identifying a risk entity. For example, the risk entity may be identified by name and address, market participant identifier (MPID), market mnemonic, and/or the like. At step 304, the input indicating the risk entity identification information is received by the limits module 230 (e.g., operating on the monitoring server 200).

The portal may then display a prompt for the user to provide limit information, possibly via the user computing device 10. For example, the portal may prompt the user (e.g., operating a user computing device 10) to provide a breach limit and/or one or more early-warning limits. In some embodiments, the early-warning limits may be predetermined and the user may only be prompted to provide a breach limit (e.g., the early-warning limits may be particular percentages of the breach limit, and/or the like). At step 306 the input indicating the limit information is received by the limits module 230 (e.g., operating on the monitoring server 200) and stored in association with the risk entity identification information. In various embodiments, a user may modify the limit information associated with a risk entity intra-day (e.g., if the user provides a new limit at 10 am and the new limit is exceeded at 2 pm, an alert will be transmitted to the user shortly after 2 pm, regardless of the previous limit).

In various embodiments, the breach limit may be a variety of measures related to a risk entity's trading activity and/or risk exposure. For example, the breach limit may be a particular monetary amount spent in trades by the risk entity, a net notional value of trades associated with the risk entity, a certain value of a particular risk exposure metric, and/or the like. In some embodiments, a breach limit corresponds only to a total value related to the risk entity's trading activity and/or risk exposure. In other embodiments, the breach limit may correspond to a frequency of trading activity and/or risk exposure. For example, if a risk entity participates in trades having a net notional value of half of the breach limit associated with the risk entity or a specified dollar amount (e.g., half a million dollars or the like) in two hours, or the like, an alert may be transmitted. Although particular exemplary limits have been described above, it should be understood that such are non-limiting and that any of a variety of limits may be established, as may be desirable for certain users according to various embodiments and/or applications

In various embodiments, one or more early-warning limits may be set in addition to a breach limit. In some embodiments, the early-warning limits are preset. For example, early-warning limits may be automatically set for 50%, 75%, and 90% of the breach limit, every quarter of a million dollars spent, and/or the like. In other embodiments, the limits module 230 may receive input indicating one or more early-warning limits. In various embodiments, the early-warning limits may be set with respect to the same or different risk exposure metric as the breach limit. The early-warning limits may correspond to a total value related to the risk entity's trading activity and/or risk exposure, or a frequency related measure of the risk entity's trading activity and/or risk exposure. Although particular exemplary percentage-based limits have been described above, it should be understood that such are non-limiting and that any of a variety of limits may be established, as may be desirable for certain users according to various embodiments and/or applications.

In various embodiments, the user may be prompted to provide input indicating limit information regularly or periodically. For example, the user may be reminded to regularly or periodically to review the established limits to ensure the established limits support current trading practices. In other embodiments, the user may be reminded to review the established limits after a certain amount time (e.g., 6 weeks, 3 months, and/or the like) has passed since the limit was established or last reviewed. The reminder may be provided via email, a pop up message upon logging into the web-accessible portal, and/or the like. In some embodiments, a reminder may not be provided.

If the user has not yet provided user alert preferences, the portal may the display a prompt for the user to provide user alert preferences. The user alert preferences may comprise an alert format (e.g., email, SMS text message, voice mail, pop dialog box, on-screen alert, portal alert, and/or any other suitable communication format), an electronic address that alerts should be transmitted to, and/or the like. If the user has already established global user alert preferences and/or risk entity specific user alert preferences, the user may not be prompted to enter user alert preferences. Rather, the user may be provided with a link, button or the like that may be selected for the user to update the previously submitted user alert preferences as the user sees fit. The input indicating the user alert preferences may be received and stored in association with the risk entity identification information at step 308. It should be understood, that the user alert preferences described herein are intended to be illustrative and not meant to be limiting. A variety of user alert preferences may be established, as may be desirable for certain users according to various embodiments and/or applications.

As noted above, in various embodiments, a breach alert or an early-warning alert may be sent to a user computing device 10 if the breach limit or one of the early-warning limits is reached and/or surpassed by trading activity and/or risk exposure associated with the risk entity. In various embodiments, a user may provide one set of user alert preferences for both breach alerts and early-warning alerts. In other embodiments, a user may provide different sets of user alert preferences for breach alerts and early-warning alerts. For example, the user may provide input indicating that they wish to receive early-warning alerts via email and wish to receive breach alerts via SMS text message, and/or the like.

Monitoring Module 240

In various embodiments, the monitoring module 240 (e.g., operating on the monitoring server 200) is configured to receive trading activity data from one or more clearing systems 30. The received trading activity data may represent trading activity broker-to-broker equity, listed corporate and/or municipal bond and unit investment trust trading and/or the like cleared in a variety of exchanges, Electronic Trading Systems, a range of additional dark pools and liquidity destinations, and/or the like. The monitoring module 240 may be further configured to consolidate the trading activity data such that the one or more risk exposure metrics related to a risk entity may be calculated. In various embodiments, the monitoring module 240 may be further configured to determine if the trading activity and/or risk exposure of a risk entity has reached or surpassed the one or more early-warning limits and/or the breach limit associated with the risk entity. If the monitoring module 240 determines that an early-warning limit and/or breach limit associated with the risk entity has been reached, surpassed, and/or otherwise triggered, the monitoring module 240 may be configured to provide an alert in accordance with the user alert preferences associated with the risk entity. In various embodiments, the monitoring module 240 may be configured to generate one or more reports comprising trading activity data associated with the risk entity. In various embodiments, a report may be provided with an alert and/or otherwise provided based on user preferences (e.g., at the end of the day, end of the week, one or more predetermined times during the day, week, month, or year, and/or the like) The monitoring module 240 will now be described in more detail with respect to FIG. 4A.

FIG. 4A is a flowchart showing the processes performed by the monitoring module 240 in one embodiment. At step 402, the monitoring module 240 receives trading activity data form one or more clearing systems 30. In various embodiments, the trading activity data may comprise a data record for each trade cleared through the clearing house, clearing firm, and/or the like operating and/or associated with the clearing system 30. The data record may comprise identifying information for each of the risk entities participating in the trade, terms associated with the trade (e.g., an interest rate, actual principle amount, maturity date, and/or the like), a notional value of the trade, a CUSIP for the security traded, the date and time of the trade, and/or the like.

At step 404, the monitoring module 240 may consolidate the trading activity data received from the one or more clearing systems 30. For example, the monitoring module 240 may parse each trade data record to determine the participating risk entities and then store at least some of the information associated with the trade data record in association with each of the participating risk entities. For example, the CUSIP of the traded security, the date and time of the trade, the notional value of the trade, the risk entities role in the trade (e.g., buyer, seller, and/or the like) may be stored in association with the risk entity. In various embodiments, at least a portion of this information may be made available on a real-time, near real-time, intra-day, end-of-day and/or monthly basis for viewing by the user via the web-accessible portal. For example, in some embodiments, a report may be generated comprising at least a portion of the trading activity data associated with the risk entity and made available via the web-accessible portal.

At step 406, the monitoring module 240 is configured to calculate one or more risk exposure metrics. In various embodiments, one or more risk exposure metrics are calculated for each risk entity at regular intervals, (e.g., every minute, every five minutes, every 10 minutes, every half hour, and/or the like). In other embodiments, one or more risk exposure metrics may be calculated for a risk entity every time information related to a trade is stored in association with the risk entity. For example, every time the monitoring module 240 receives information that a risk entity participated in a trade, the monitoring module may calculate one or more risk exposure metrics for the risk entity. In yet other embodiments, the monitoring module 240 may be configured to calculate the one or more risk exposure metrics for the risk entity every other time or every third time or the like that information related to a trade is stored in association with the risk entity.

In various embodiments, the one or more risk exposure metrics may be calculated based on a variety of algorithms. The risk exposure metrics may be common metrics used by the industry to calculate risk exposure and/or other risk exposure metrics. In some embodiments, at least one risk exposure metric is calculated based on the gross notional values of the trades associated with the risk entity. In some embodiments, at least one risk exposure metric may be calculated based on the net notional value of the trades associated with the risk entity. A variety of risk exposure metrics may be calculated in order to monitor the trading activity and/or the risk exposure of the risk entity.

In various embodiments, one or more risk exposure metrics may take into account information in addition to the consolidated trading activity data. For example, in various embodiments, the user may be able to log-in to the web-accessible portal, via the user computing device 10, and provide input indicating start-of-day exposure information for a risk entity. For example, the start-of-day exposure information may include risk exposure associated with the risk entity based on the portfolio of the risk entity, the net notional value of the portfolio of the risk entity, assets held by the risk entity, debts held by the risk entity, and/or the like.

At step 408, the monitoring module 240 compares the one or more risk exposure metrics against the limit information associated with the risk entity. For example, in one embodiment, the monitoring module 240 may compare the net notional value of the trades associated with the risk entity to the one or more early-warning limits and/or the breach limit associated with the risk entity.

At step 410, it is determined whether an early-warning limit has been reached and/or surpassed. If an early-warning limit has not been reached and/or surpassed, the monitoring module 240 returns to step 402. If an early-warning limit has been reached and/or surpassed, the monitoring module 240 proceeds to step 412. At step 412, the monitoring module 240 determines if the breach limit has been reached and/or surpassed. If the breach limit has not been reached and/or surpassed, the monitoring module 240 may proceed to step 414 and may transmit an early-warning alert in accordance with user alert preferences stored in association with the risk entity. In various embodiments, the early-warning alert may be automatically generated, provided, and/or transmitted (e.g., to the user computing device 10, provided electronic address, and/or the like). The monitoring module 240 may then return to step 402. If the breach limit has been reached and/or surpassed, the monitoring module 240 may proceed to step 416 and may transmit a breach alert in accordance with user alert preferences stored in association with the risk entity. In various embodiments, the breach alert may be automatically generated, provided, and/or transmitted (e.g., to the user computing device 10, provided electronic address, and/or the like). In various embodiments, a report comprising at least a portion of the consolidated trading data associated with the risk entity may be automatically generated if an early-warning or breach alert is triggered (e.g., an early-warning or breach limit is reached, surpassed, or otherwise triggered). The report may be provided with the alert, made available via the web-accessible portal, stored in association with the risk entity, and/or the like. The monitoring module 240 may then return to step 402.

FIGS. 4B and 4C are flowcharts showing processes performed by the monitoring module 240 in other embodiments. In the embodiment shown in FIG. 4B, steps 402b, 404b, 406b, and 408b may be completed similar to steps 402, 404, 406, and 408 described above. At step 410b, the monitoring module 240 may determine if the pre-established breach limit has been reached and/or surpassed based at least in part on the calculated one or more risk exposure metrics. If it is determined that the breach limit has been reached and/or surpassed, the monitoring module 240 may generate, provide, and/or transmit (e.g., to the user computing device 10, provided electronic address, and/or the like) a breach alert at step 412b, before returning to step 402b. If it is determined that the breach limit has not been reached and/or surpassed, the monitoring module 240 may continue to step 414b. At step 414b, the monitoring module 240 determines if an early-warning limit has been reached and/or surpassed based at least in part on the calculated one or more risk exposure metrics. If it is determined that an early-warning limit has not been reached and/or surpassed, the monitoring module 240 may return to step 402b. If it is determined that an early-warning limit has been reached and/or surpassed, the monitoring module 240 may continue to step 416b. At step 416b, an early-warning alert may be generated, provided, and/or transmitted (e.g., to the user computing device 10, provided electronic address, and/or the like), before returning to step 402b.

FIG. 4C shows a process performed by the monitoring module 240 in another embodiment of the present invention. Particularly, FIG. 4C illustrates an embodiment in which no early-warning limits are set. In the embodiment shown in FIG. 4C, steps 402c, 404c, 406c, and 408c may be completed similar to steps 402, 404, 406, and 408 described above. At step 410c, the monitoring module 240 determines if the breach limit has been reached and/or surpassed based at least in part on the calculated one or more risk exposure metrics. If it is determined that the breach limit has been reached and/or surpassed, the monitoring module 240 may generate, provide, and/or transmit (e.g., to the user computing device 10, provided electronic address, and/or the like) a breach alert at step 412c, before returning to step 402c. If the breach limit has not been reached and or surpassed, the monitoring module 240 may return to step 402c.

In various embodiments, a breach or early-warning alert may comprise a variety of information. For example, in some embodiments an early-warning alert may simply state “Risk Entity A has surpassed 50% of the established breach limit,” and/or the like. In other embodiments, the alert may comprise information associated with one or more trades associated with the risk entity and/or other information. For example, a report comprising at least a portion of the consolidated trading data may be provided with the alert. In various embodiments, the user may be prompted to perform one or more mitigating activities in response to receiving a breach or early-warning alert. In some embodiments, a breach or early-warning alert may include instructions and/or a mechanism for acknowledging receipt of the alert. In some embodiments, the content of the alert may depend on the format of the alert (e.g., an email alert may contain more information than an SMS text alert) and/or the user alert preferences associated with the risk entity.

In various embodiments, a breach or early-warning alert may be transmitted once or multiple times. For example, in some embodiments, a breach or early-warning alert may only be generated and transmitted the first time that day the risk entity's trading activity and/or risk exposure reaches and/or surpasses the breach or early-warning limit. In some embodiments, every time it is determined that the risk entity has engaged in trading activity and the risk entity's trading activity and/or risk exposure has reached and/or surpassed the breach limit, an alert may be generated and transmitted. In some embodiments, a breach alert may be generated and/or transmitted each time it is determined that the risk entity has engaged in trading activity and the risk entity's trading activity and/or risk exposure has reached and/or surpassed the breach limit until user input indicating the alert has been received is received. In various embodiments, the monitoring module 240 may be configured to generate and/or transmit a reminder if mitigating activity is not taken by the user and/or the alert is not acknowledged by the user within a certain time period (e.g., 5 minutes, 10 minutes, and/or the like) or within receiving a certain amount of trading activity data associated with the risk (e.g., trading activity data is received for 2 or 3 trades associated with the risk entity, and/or the like). In some such embodiments, the number of times an alert may be transmitted is determined by the user alert preferences associated with the risk entity.

As described herein, the limits module 230 and monitoring module 240 are separate modules operating on the monitoring server 200. In various embodiments, the functionality of the modules 230, 240 may be implemented via various methods other than those disclosed herein. For example, in some embodiments, the limits module 230 may be responsible for receiving start-of-day exposure information, which is described herein with regard to the monitoring module 240. In another example, modules 230 and 240 may be combined into a single module and/or may operate on a computing system separate from and in communication with the monitoring server 200. Thus, modules 230, 240 are described as separate modules herein in order to describe various functions of the various embodiments, rather than to be limiting.

It should be appreciated that, while the above discussion refers to a single risk entity associated with a single user, the disclosed Risk Mitigation Tool may be configured to associate one or more risk entities with a user and/or may be configured to support use by one or more users. In some embodiments, a risk entity may be associated with more than one user.

### Conclusion

Many modifications and other embodiments of the invention set forth herein will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

That which is claimed:

1. A system comprising:
at least one memory for storing one or more limits, each limit associated with a risk entity;
at least one processor, said at least one processor configured to:
receive trading activity data associated with said risk entity from a plurality of sources;
consolidate said received trading activity data;
execute a predetermined algorithm to calculate at least one risk exposure metric based at least in part on said consolidated trading activity data;
determine, based at least in part on said calculated risk exposure metric, whether at least one of said one or more limits associated with said risk entity has been triggered; and
generate an alert indicative of said triggering of said at least one of said one or more limits.

2. The system of claim 1 wherein one of said one or more limits is triggered when said limit is at least one of reached or surpassed.

3. The system of claim 1 wherein each of said one or more limits is at least one of a breach limit or an early-warning limit.

4. The system of claim 1, wherein said at least one processor is further configured to execute a second predetermined algorithm to calculate at least one second risk exposure metric based at least in part on start-of-day exposure information.

5. The system of claim 1 wherein said at least one risk exposure metric is calculated based on a net notional value associated with said risk entity.

6. The system of claim 1, wherein said at least one processor is further configured to:
at least one of automatically or periodically generate a report comprising at least a portion of said consolidated trading activity data associated with said risk entity; and
at least one of automatically or periodically transmit said report to one or more users of the system.

7. The system of claim 6, wherein said report comprises at least one of a CUSIP of at least one traded security, a notional value associated with at least one trade, a date and time of at least one trade, one or more terms associated with at least one trade, and one or more counterparties associated with at least one trade.

8. The system of claim 1 wherein said one or more limits comprise a breach limit and one or more early-warning limits, at least one of said one or more early-warning limits is at least one of 50%, 75%, or 90% of said breach limit.

9. A computer-implemented method for monitoring trading limits of a risk entity, said method comprising:
receiving and storing within one or more memory storage areas trading activity data associated with said risk entity from a plurality of sources;
consolidating, via at least one processor, said received trading activity data;
executing, via the at least one processor, a predetermined algorithm to calculate at least one risk exposure metric, said calculation of said at least one risk exposure metric being based at least in part on said consolidated trading activity data;
determining, via the at least one processor, based at least in part on said calculated risk exposure metric, whether at least one of one or more limits associated with said risk entity has been triggered; and
generating, via the at least one processor, an alert indicative of said triggering of said at least one of said one or more limits.

10. The method of claim 9 wherein one of said one or more limits is triggered when said limit is at least one of reached or surpassed.

11. The method of claim 9 further comprising receiving at least one limit associated with said risk entity and causing said at least one limit to be stored in the one or more memory storage areas.

12. The method of claim 9 wherein each of said one or more limits is at least one of a breach limit or an early-warning limit.

13. The method of claim 9, further comprising executing a second predetermined algorithm to calculate at least one second risk exposure metric based at least in part on start-of-day exposure information.

14. The method of claim 9 wherein said at least one risk exposure metric is calculated based on a net notional value associated with said risk entity.

15. The method of claim 9, further comprising:
at least one of automatically or periodically generating a report comprising at least a portion of said consolidated trading activity data associated with said risk entity; and
at least one of automatically or periodically transmitting said report to one or more users of the system.

16. The method of claim 15, wherein said report comprises at least one of a CUSIP of at least one traded security, a notional value associated with at least one trade, a date and time of at least one trade, one or more terms associated with at least one trade, and one or more counterparties associated with at least one trade.

17. The method of claim 9 wherein said one or more limits comprise a breach limit and at least three early-warning limits, said early-warning limits comprising a first early-warning limit equal to 50% of said breach limit, a second early-warning limit equal to 75% of said breach limit, and a third early-warning limit equal to 90% of said breach limit.

18. A computer program product comprising at least one non-transitory computer-readable storage medium having computer-readable program code portions stored therein, the computer-readable program code portions comprising:
an executable portion configured to store one or more limits, each limit associated with a risk entity;
an executable portion configured to receive trading activity data associated with said risk entity from a plurality of sources;
an executable portion configured to consolidate said received trading activity data;
an executable portion configured to execute a predetermined algorithm to calculate at least one risk exposure metric based at least in part on said consolidated trading activity data;
an executable portion configured to determine, based at least in part on said calculated risk exposure metric, whether at least one of said one or more limits associated with said risk entity has been triggered; and
an executable portion configured to generate an alert indicative of said triggering of said at least one of said one or more limits.

19. The computer program product of claim 18 wherein one of said one or more limits is triggered when said limit is at least one of reached or surpassed.

20. The computer program product of claim 18 wherein each of said one or more limits is at least one of a breach limit or an early-warning limit.

21. The computer program product of claim 18, further comprising an executable portion configured to execute a second predetermined algorithm to calculate at least one second risk exposure metric based at least in part on start-of-day exposure information.

22. The computer program product of claim 18 wherein said at least one risk exposure metric is calculated based on a net notional value associated with the risk entity.

23. The computer program product of claim 18, further comprising:
an executable portion configured to at least one of automatically or periodically generate a report comprising at least a portion of said consolidated trading activity data associated with said risk entity; and
at least one of automatically or periodically transmit said report to one or more users of the system.

24. The computer program product of claim 23, wherein said report comprises at least one of a CUSIP of at least one traded security, a notional value associated with at least one trade, a date and time of at least one trade, one or more terms associated with at least one trade, and one or more counterparties associated with at least one trade.
